(19) United States
(12) Patent Application Publication
(10) Pub. No.: US 2009/0234721 A1
(43) Pub. Date: Sep. 17, 2009

(54) PERSISTENT COLLABORATIVE ON-LINE MEETING SPACE

(76) Inventors: David H. Bigelow, Greenwood, IN (US); Andrew M. Westberg, Noblesville, IN (US)

Correspondence Address: BOSE MCKINNEY & EVANS LLP, 111 MONUMENT CIRCLE, SUITE 2700, INDIANAPOLIS, IN, 46204, US

(21) Appl. No.: 12/341,196

(22) Filed: Dec. 22, 2008

Related U.S. Application Data
(60) Provisional application No. 61/015,682, filed on Dec. 21, 2007.

(51) Int. Cl. G06Q 10/00; G06F 3/048; G06F 21/00

(52) U.S. Cl. 705/12; 715/753; 726/4

(57) ABSTRACT

A system and method for establishing persistent collaborative on-line meeting spaces for a plurality of participants located at a plurality of different locations using computing devices across a communication network. The system includes sending invitations to the plurality of participants, and establishing the identity of potential attendees and only allowing authorized participants to enter the meeting space. The system also includes creating a virtual workspace on a workspace computer wherein the participants can interact. The interaction can include creating, adding, organizing, and deleting meeting content. The system also records status, movement and modification of the meeting content and participant activities during the meeting for later playback. The system can use user contributed objects and content, virtual sticky notes, organizer tools and other items, and can support multiple security levels.

### CROSS REFERENCE TO RELATED APPLICATIONS

This application claims the benefit of U.S. Provisional Application Ser. No. 61/015,682, filed on Dec. 21, 2007, entitled “A Persistent Collaborative On-Line Meeting Space,” which is incorporated herein by reference

### BACKGROUND AND SUMMARY

Companies, teams, groups and individuals spend a lot of time in meetings. Most meetings are a “physical” process, you have to be “physically” present at the meeting to be effective. Most meetings are characterized by a coordinator/leader for the meeting, and others (attendees), as well as various stakeholders (e.g. management, employees, vendors, investors, volunteers, etc.) who may or may not be able to attend but need to participate and be kept informed in the meetings and their outcomes.

With the increasing number of people involved in meetings (e.g. management, employees, vendors and other relationships inside and outside of a company), information often gets hard to manage, track and disseminate to all parties involved or interested. Adding to that are the complexities of enabling people to contribute to, or even attend, a meeting in a timely and efficient manner; specifically, capturing ideas and feedback in real time, organizing them and making them easy to understand and share. This usually suffers due to the limited amount of time people have and the dispersion of people throughout the state, country or world that are expected to collaborate effectively. The ability to maintain attendance levels over multiple meetings and effectively disseminate the information to keep everyone informed is a growing problem in many environments.

One problem is that information collected during a meeting is usually summarized, distributed and maintained by one person. This typically results in the loss of input, filtering of the meeting inputs, and an increase in follow-up and overlapping communications regarding previous meeting inputs and results.

Except for meeting minutes, which are typically high level bullet-points or summary notes, attendees have no record of what happened in a meeting, who contributed an idea and when, or a way to visually correlate the meeting inputs to the discussions during the meeting. Some meetings are highly visual in nature, using tools like whiteboards, internet web sites, computer based presentations (e.g. PowerPoint), sticky note processes (e.g. brainstorming, affinity diagramming processes, etc.), and combinations there of. All of the meeting input, especially the visual inputs like sticky note processes are impossible to share effectively without significant effort to reproduce them electronically, and even then they do not retain their visual association as presented at the physical meeting.

Since most meetings are physical/visual processes, even with the advent of tools like web-ex, go-to-meeting and other internet based meeting tools, it is nearly impossible to make an effective connection to a meeting while remotely trying to participate and contribute to the visual/physical process.

With the technology described in this application, the “physical” process of conducting and participating in meetings can be effectively done in an on-line environment. A “persistent” collaborative meeting space can be created which groups and individuals can use to parallel the “physical” process of meeting but in a visual and real-time environment—with no loss of the process or inputs, no loss of when they occurred and/or no loss of who contributed or modified them.

Meetings can be “persistent” in that they never have to end and their content is not actually deleted, rather “snap-shots” can be created throughout the life of the meeting as items change to keep key history of input, process and organization related thereto. Meeting content can be organized and reorganized at any time by any participant with the appropriate permissions, and all content (its creation, reorganization and/or deletion) can be captured and maintained for future use/review

A meeting can be setup as a virtual meeting room of various subjects and content references which can enable participants to do various things, such as freehand draw on subject spaces, place external content, relate items to each other visually or using organization tools within the environment. Since meetings are persistent and on-line (using the Internet or any network), participants do not have to attend at a prescribed time to be effective in the meeting. Rather, participants can call/logon into the meeting; communicate via the meetings collaborative tools, voice and/or video conferencing services; and choose to attend at a pre-determined meeting time or catch up with the meeting at a later time. Participants who miss key meeting times in the collaborative space can “replay” the meeting to see what ideas were contributed, when and by whom they were contributed, and view this replay in real, accelerated or decelerated time including audio, video and movements/organizations of information.

Meetings can include tools for helping to capture inputs from participants, such as “virtual sticky notes.” Virtual sticky notes can be used as part of the collaborative process to facilitate input of multiple participants at various locations and enable a visual organization of ideas. The sticky notes can be “stuck” to each other, and organized in relation to any other object within the virtual meeting space.

Meetings, subjects and items can be “linked” to other meetings, subjects and items and can maintain the “linked” relationships as a snap-shot of the linked item, or as something that dynamically updates based on changes to the linked meeting, subject or item. Linked items can also change and push those changes back to other meetings, subjects or items. Meetings, subjects and items within the system can be given different security levels by a meeting participant or administrator to prevent unauthorized viewing.

Additional features and advantages of the invention will become apparent to those skilled in the art upon consideration of the following detailed description of illustrated embodiments.

### BRIEF DESCRIPTION OF THE FIGURES

Aspects of the present invention are more particularly described below with reference to the following figures, which illustrate exemplary embodiments of the present invention

FIG. 1 is a block diagram of an exemplary environment for a persistent interactive meeting space;

FIG. 2 illustrates how meeting participants in various dispersed locations can interact through in an embodiment of a persistent interactive meeting space of the present invention;

FIG. 3 illustrates the flow of meeting topics into the system, through interactive discussions resulting in outputs for distribution to various interested parties;

FIG. 4 illustrates an embodiment of a meeting interface;

FIG. 5 illustrates one embodiment of system organization by projects and meetings, and a screen shot of an alternative virtual meeting space for a selected meeting;

FIG. 6 illustrates an embodiment of system organization by projects and meetings with each meeting having an agenda with objectives and a hyperlink to the virtual meeting space or recording;

FIG. 7 illustrates an embodiment of the on-line meeting interface with an organizer pane, view port and other features;

FIGS. 8A and 8B illustrate an embodiment of a meeting organizer and alternative orientations for the meeting organizer;

FIG. 9 illustrates an example of a note object and some of the possible capabilities for a note object;

FIGS. 10 and 11 illustrate an embodiment of the parent-child associations and behaviors of note objects;

FIG. 12 illustrates an embodiment of the movement of note objects into a group pane;

FIG. 13 illustrates an embodiment of the reorganization of note objects within a group pane;

FIG. 14 illustrates an embodiment of the reorganization of group panes;

FIG. 15 illustrates an embodiment of a stone and its grouping attributes;

FIG. 16 illustrates an embodiment of a note with an anchor property and some of the attributes of the anchor property;

FIGS. 17A, B and C illustrate some equivalents of the embodiments of different organizational tools;

FIG. 18A illustrates a notes grouping method using a lasso with an anchor note;

FIG. 18B illustrates the notes grouping method of FIG. 20A without an anchor note;

FIGS. 19A and 19B illustrate embodiments of relationships between notes and other objects; and

FIG. 20 illustrates an embodiment of a virtual scrolling through a stack of note objects.

### DETAILED DESCRIPTION OF EXEMPLARY EMBODIMENTS

With the advent of new internet technologies and processes and the technology described in this application, the “physical” process of conducting and participating in meetings can be effectively done in an on-line environment. A “persistent” collaborative meeting space can be created which companies, groups and individuals can use to parallel the “physical” process of meeting but in a visual and real-time environment. This meeting space can enable no loss of the process or inputs, no loss of when they happened and/or no loss of who contributed to them or changed their content.

Meeting coordinators can setup meetings, establish meeting participation requirements and permissions, send meeting invitations and maintain control of the meeting process.

Meetings are “persistent” in that they never have to end and their content is not actually deleted, rather “snap-shots” can be created throughout the life of the meeting as items change to keep key history of input, process and organization related thereto. Meeting content can be organized and reorganized at any time by any participant with the appropriate permissions, and all content (its creation, reorganization and/or deletion) is captured and maintained for future use/review.

A meeting can be setup as a virtual meeting room of various subjects and content references which can enable participants to do various things, such as freehand draw on subject spaces, place external content (e.g., documents, images, hyperlinks, and other commonly known/anticipated items), and relate items to each other visually or using organization tools within the environment.

Since meetings are “persistent” and on-line (using the Internet or any network), participants do not have to be “physically” in attendance at a prescribed time to be effective in the meeting. Participants can call/logon into the meeting; communicate via the meetings collaborative tools, voice and/or video conferencing services; and choose to attend at a pre-determined meeting time or catch up with the meeting at a later time (e.g. due to travel, time zone differences, etc.). Participants who miss key meeting times in the collaborative space can “replay” the meeting to see what ideas were contributed, when and by whom they were contributed, and view this replay in real, accelerated or decelerated time including audio, video and movements/organizations of information.

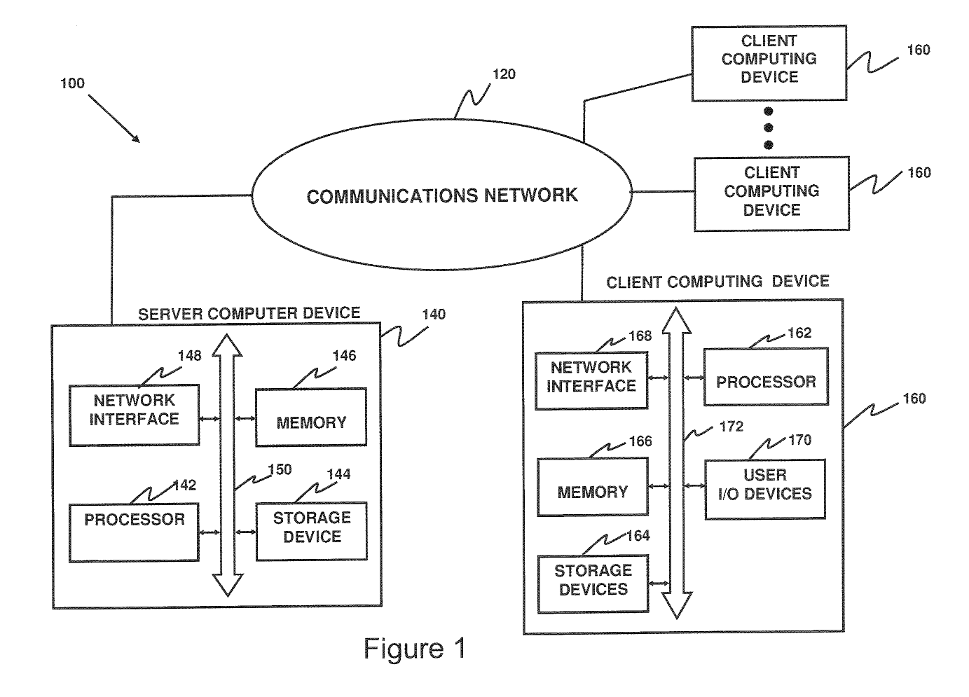

FIG. 1 shows a block diagram of an exemplary environment for a system according to the present invention. The environment 100 includes a communications network 120, at least one server computing device 140, and at least one of a plurality of client computing devices 160. The communications network 120 operably couples the server computing device 140 and the client computing devices 160 such that the server computing device 140 and the client computing devices 160 may share information. The communications network 120 can be the Internet, and/or any other suitable collection of devices that is connected to share information. It should be readily appreciated that the communications network 120 may include multiple public and/or private Local Area Networks (“LANs”) and/or Wide Area Networks (“WANs”) that are operably coupled to one another via routers, switches, hubs, gateways, firewalls, and/or other devices (not shown). Additionally, it is noted that the communications network 120 may include a hardwired telephone network, a wireless telephone network, and/or a satellite network. Of course the system can be operated in other environments known to those of skill in the art, for example peer-to-peer and other network types and topologies.

In general, the server computing device 140 can be implemented with a server computer system or web server. The server computing device 140 may also include network server appliances, server farms, server clusters, network accessible storage devices, and/or any other device suitable for executing operations according to the present invention. In the exemplary embodiment of FIG. 1, the server computing device 140 includes a processor 142, a storage device 144, memory 146, a network interface 148, and a system bus 150.

The processor 142 is generally operable to obtain software and/or firmware instructions from the storage device 144, load them into memory 146, and execute the instructions from memory 146. The storage device 144 is generally operable to store data and/or software instructions for the server computing device 140. The storage device 144 can include a hard disk drive, a floppy disk drive, a CD-ROM drive, a DVD drive, and/or any other suitable computer readable and/or writeable media device. Additionally, the storage device 144 may include multiple media devices and may be distributed among several computing devices such as other servers of a server farm, other database servers, or other network accessible storage (“NAS”) devices.

Memory 146 stores data and instructions used by the processor 142. The memory 146 can include random access memory for storing the data and software instructions needed by the processor 142. Alternatively, memory 146 may include other locally available or remotely distributed volatile and/or non-volatile storage mediums. The network interface 148 operably couples the server computing device 140 to the communications network 120 such that the server computing device 140 may communicate with the at least one of the plurality of client computing devices that are also operably coupled to the communications network 120. The system bus 150 is generally operable to interconnect the processor 142, the storage device 144, memory 146, and the network interface 148, and to enable these components of the server computing device 140 to communicate with one another.

The client computing devices 160 can have various different embodiments, for example a desktop or portable computer, a handheld computer, a PDA, an Internet enabled cellular telephone, a set-top box, a network appliance, a gaming console and/or any other suitable network enabled computing device. An exemplary embodiment for the client computing device 160 shown in FIG. 1 includes a processor 162, a storage device 164, memory 166, a network interface 168, one or more user I/O devices 170, and a system bus 172.

The processor 162 is generally operable to obtain software and/or firmware instructions from the storage device 164 or delivered from the server computer device 140 via the network 120 and the network interface 168, load them into memory 166, and execute the instructions from memory 166. The storage device 164 is generally operable to store data and/or software instructions for the client computing device 160. The storage device 164 may include a hard disk drive, a floppy disk drive, a CD-ROM drive, a DVD-RAM drive, and/or other suitable computer readable and/or writeable media device. Additionally, the storage device 164 may include multiple media devices and may be distributed among several computing devices or other Network Accessible Storage (NAS) devices.

Memory 166 stores data and instructions used by the processor 162. The memory 166 can include volatile and/or non-volatile memory types. The network interface 168 operably couples the client computing device 160 to the communications network 120 such that the client computing device 160 may communicate with the server computing device 140 and/or other client computing devices 160 via the communications network 120. The system bus 172 is generally operable to enable the various components of the client computing device 160 to communicate with one another.

The client computing device 160 can also include one or more user I/O devices 170. In general, the user I/O devices 170 provide a user of the client computing device 160, with mechanisms for entering information into, receiving information from, and/or controlling the operation of the client computing device 160 and/or the server computer device 140. The user I/O devices 170 can include displays, monitors, printers, and/or other output devices; sound cards, speakers, microphones, video cameras and/or other audio-video devices; a mouse, keyboard, touch pad, scanner, touch screen, disc drive, and/or other input devices.

The above described components of the server computing device 140 and the client computing device 160 are merely exemplary and in alternative embodiments those skilled in the art may elect to replace all or portions of these devices with other suitable components.

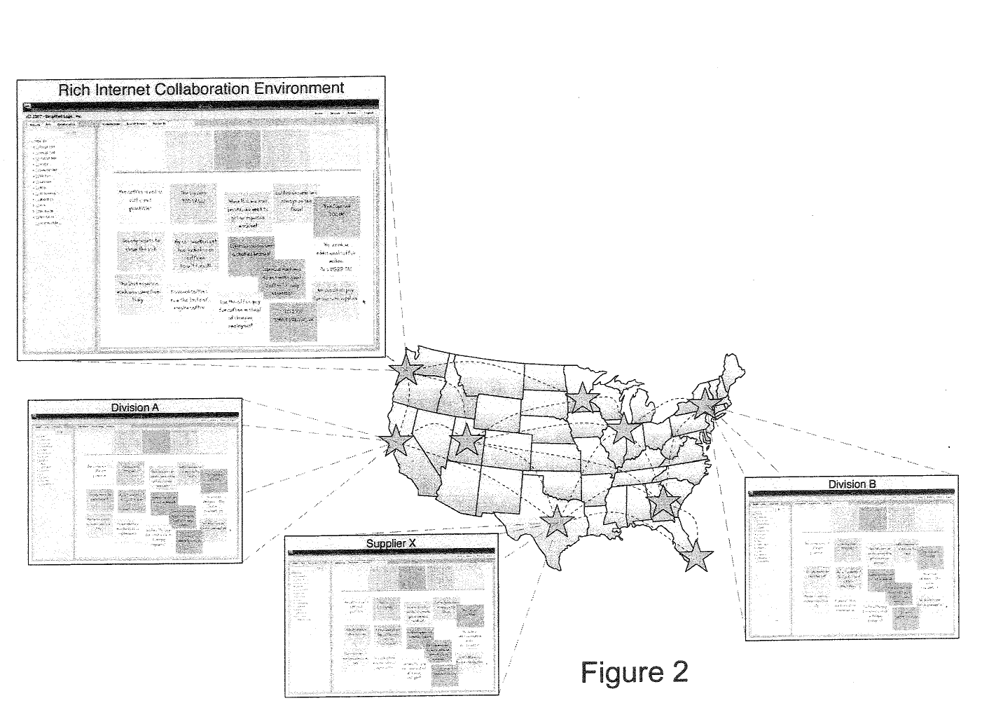

Meetings include tools for helping to capture inputs from participants. A common tool in a physical meeting space are “sticky notes”, which are commonly used to encourage brainstorming and organization of ideas using affinity diagramming techniques (as devised by Jir Kawakita in the 1960s—sometimes referred to as the KJ Method). As shown in FIG. 2, the present invention can use virtual sticky notes as one method of the collaborative process to facilitate the immediate input by multiple participants at various locations and enable a visual organization of ideas. When any participant creates and places a sticky-note, it can be displayed for all other participants at their respective locations to view, comment on, position and otherwise interact with. A “tactile” process (similar to the physical world) can be visually presented in that the sticky notes can have an audible and visual component to their manipulation and interaction by the participants. The sticky notes, as in the physical world, may be “stuck” to each other, and organized/presented in relation to any other object within the meeting and subject spaces. This would include the various methods of stacking them, and sticking them together as in the “physical” world.

Meetings, subjects and items within the system can be “linked” to other meetings, subjects and items and can maintain the “linked” relationships as a snap-shot of the linked item, or as something that dynamically updates based on changes to the linked meeting, subject or item. Linked items can also change and push those changes back to other meetings, subjects or items. Meetings, subjects and items within the system can be identified as “publicly” distributable or “private/classified” information by a meeting participant or administrator with appropriate permissions.

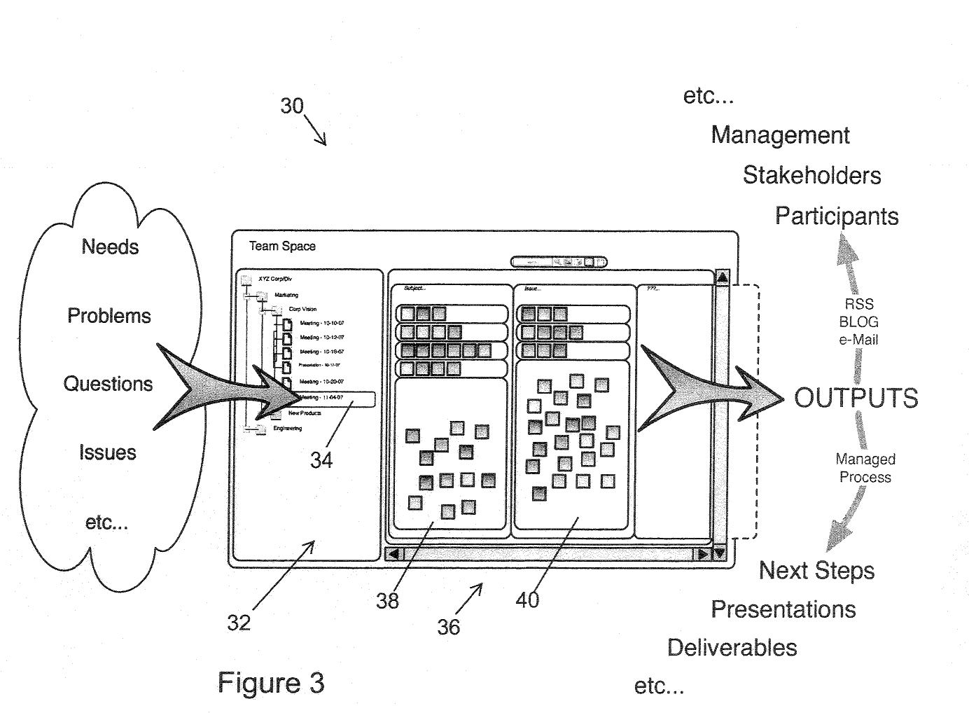

FIG. 3 illustrates a team space meeting interface 30 that can be used to hold the content of various meetings. The team space 30 includes a meeting list 32 and a meeting workspace 36. When the user selects a meeting in the meeting list 32, content associated with the selected meeting is displayed in the meeting workspace 36. In the example of FIG. 3, a meeting 34 has been selected in the meeting list 32, and a subject pane 38 and an issue pane 40 associated with the selected meeting 34 are displayed in the meeting workspace 36. A meeting can be held to address needs, problems, questions, issues and other topics regarding a particular subject. Content and ideas can be contributed by participants by entries into the appropriate working space during a scheduled meeting time, or at their convenience when they can logon to the system. At any time during this meeting process, outputs can be generated for management, stakeholders, participants or others. The outputs can include next steps reports, presentations, specified deliverables or other outputs. Embodiments of the system can automatically distribute or make available content reports and/or outputs to participants and stakeholders through the software, or through commonly used tools like standard e-mail, XML (Extensible Markup Language), RSS (Really Simple Syndication) protocol, BLOGs (on-line narratives), etc.

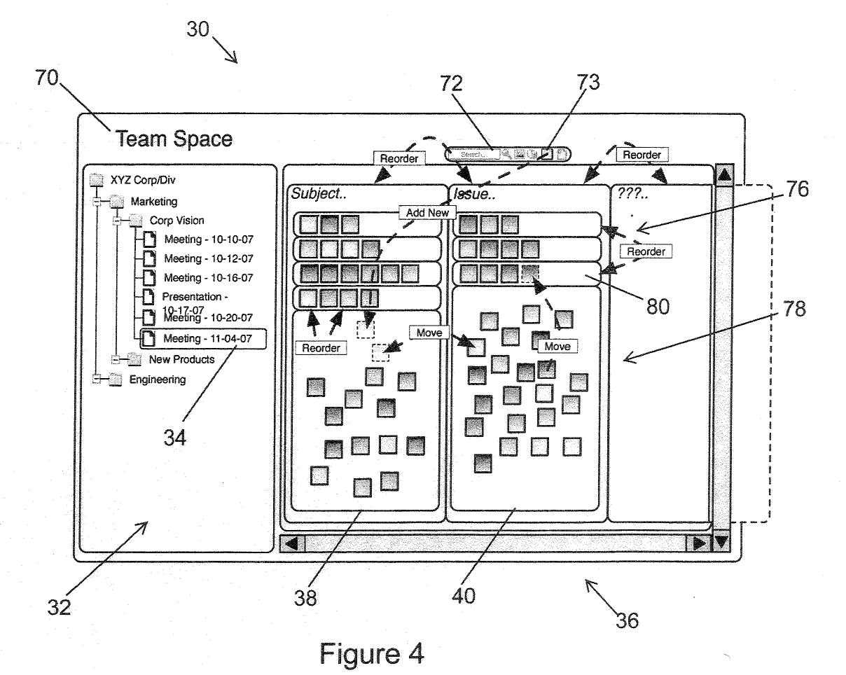

FIG. 4 provides an enlarged view of the meeting interface 30 shown in FIG. 3. This embodiment of a meeting interface 30 includes a title bar 70, a tool bar 72, the meeting selection list 32 and the working space 36. The tool bar 72 can include various tools for the user, including a search tool, a zoom tool, a create snapshot tool, a print/export tool, a note creation tool 73, an object creation tool, a focus tool and a trashcan.

An embodiment of the meeting selection list 32 can be organized into folders and can include other entries, such as presentations. When a meeting or other entry is selected from the meeting list 32, the workspace 36 is filled with the content for the selected meeting or entry. When a meeting 34 is selected, the workspace 36 includes a meeting window with panes for each subject or issue addressed in that meeting. In the example of FIG. 4, the meeting 34 has been selected in the meeting list 32, and the subject pane 38 and the issue pane 40 associated with the selected meeting 34 are displayed in the meeting workspace 36. The meeting panes and content can extend beyond the viewable window and scroll controls can be used to view the desired pane.

Each pane has an upper organizer section 76 and a lower whiteboard or brainstorming section 78. The upper organizer section 76 can include items associated by some property, for example by subject matter or by contributor, grouped one or more sub-panes 80. The content of the organizer sub-panes 80 can be rearranged by dragging the selected item in the sub-pane 80 and dropping it in the desired position in the organizer sub-pane 80. The arrangement of the organizer sub-panes 80 themselves can be reorganized by dragging the selected sub-pane 80 and dropping it in the desired position in the organizer section 76. The lower whiteboard section 78 can accommodate new items that have not yet been grouped and organized, or other independent items. When a new note is created using the note creation tool 73, it can initially be located in the whiteboard space 78 of the active pane in the working space 36. Items can be moved from the whiteboard space 78 into a sub-pane 80 in the organizer section 76 by dragging the selected item from the whiteboard space 78 and dropping it in the desired position in the organizer sub-pane 80. Items can be moved and repositioned between different areas of the meeting window by dragging and dropping the desired items.

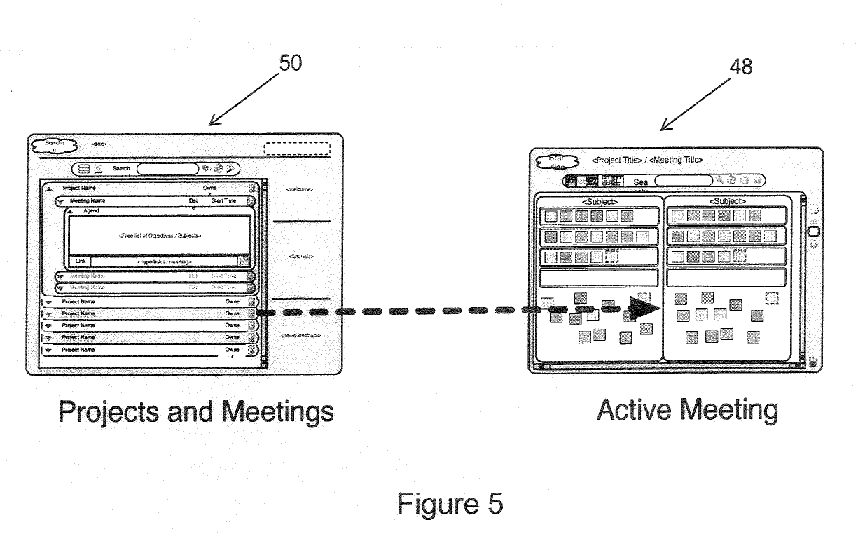

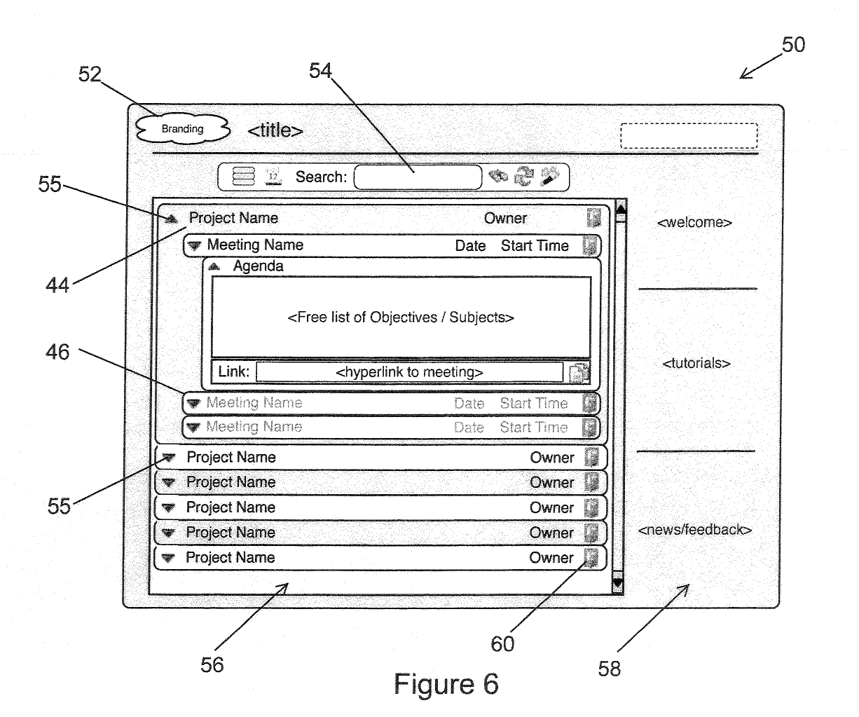

FIGS. 5 and 6 illustrate an alternative organizational structure using a home space 50 and a meeting space 48. The home space 50 lists projects and meetings that can be selected. When a meeting is selected, the meeting space 48 for the selected meeting is displayed. In this embodiment, the meeting space 48 is similar to the workspace 36 described above for the selected meeting. An exemplary embodiment of this alternative organizational structure using the home space 50 has corporate accounts broken down into projects 44 which are further separated by meetings 46. As mentioned earlier and throughout this disclosure, meetings do not have to be a time constrained process but rather can be left open until all desired participants have had a chance to contribute ideas and comments, and to review the contributions and comments of others.

The home space 50 shown in FIG. 6 includes a title bar 52, a tool bar 54, a project and meeting list 56 and a customizable area 58. The title bar 52 includes a space for branding and an appropriate title, for example the corporate account and can have additional tools if room is available. The tool bar 54 can include tools to select different information views, a search tool, a refresh tool and a create new project tool. The different information views tool can display the projects/meetings in the meeting list 56 in other arrangements, such as a calendar view. The search tool can enable a user to search all meetings in the project list for particular attributes or content. The refresh tool can refresh the meeting list 56 to capture any changes. The create new project tool can create a new project for the current corporate account. The customizable area 58 can be tailored by the organization to be helpful to the user, including items like a welcome area, a tutorial or help area, and a news/feedback area.

The project and meeting list 56 shown in FIG. 6 includes a project name and an owner for each project as well as a meeting entry icon 60. Each project 44 and meeting 46 has an expand/collapse icon 55 which can be used to expand a particular entry to provide more information or collapse a particular entry to provide more space. When a project 44 is expanded it shows the meetings 46 associated with that project 44. Different display techniques can be used to show if a meeting is active or is over, such as graying out meetings that are over.

If one meeting is currently active, then the meeting entry icon 60 for the project brings the user into the active meeting. If more than one meeting is currently active for that project, then selecting the meeting entry icon 60 for the project can display a meeting list and prompt the user to select the desired meeting. When bringing the user into the active meeting, the system may display a meeting page like the one shown on the right side of FIG. 5. If there are no active meetings for that project, then selecting the meeting entry icon 60 for the project can create a new meeting or present a window to ask the user if they want to create a new meeting.

Under each project is a list of meeting entries, each meeting entry including a meeting name, a date, a start time and a meeting entry icon 60. If the meeting is currently active, then selecting the meeting entry icon 60 of the meeting entry will bring the user into the active meeting. If the meeting is over, then selecting the meeting entry icon 60 of the meeting entry will bring the user into the meeting history. The meeting history has snapshots and other information collected during the meeting enabling the user to review/replay the meeting materials but will not allow edits of the meeting materials. When the meeting entry is expanded, a meeting sub-pane is displayed that contains key information concerning the meeting; for example, an agenda, a list of objectives and subjects and a hyperlink to the meeting.

The system can enable voting or other organizational tools or methods for items, groups of items, or entire subjects within a meeting. This can be used by participants or other stakeholders to help prioritize meeting issues and feedback for the current or future meetings, and can be used by those unable to “physically” attend the meeting but who may have interest in the results or real-time progress of the meeting's content and directions. Organizational tools and methods can be detected by the system and automatically distribute the content reports to participants and stakeholders through the software, or through commonly used tools like standard e-mail, XML (Extensible Markup Language), RSS (Really Simple Syndication) protocol, BLOGs (on-line narratives), etc.

The system can also enable users to create their own object types (e.g. similar to meetings, subjects and items like sticky notes) and their own behaviors which they can include in the meeting space. The software environment allows for this and other similar integrations and variations. The meeting space can also be addressed from remote systems using methods familiar to those of ordinary skill in the art (e.g. database access, web service interfaces, etc.) to allow other business and meeting systems to “consume” information from the system and “push” content into it (e.g. creating/modifying meetings/subjects/items from groupware programs like Microsoft Exchange or LotusNotes, or pushing updates to the meeting space from project systems like Microsoft Project).

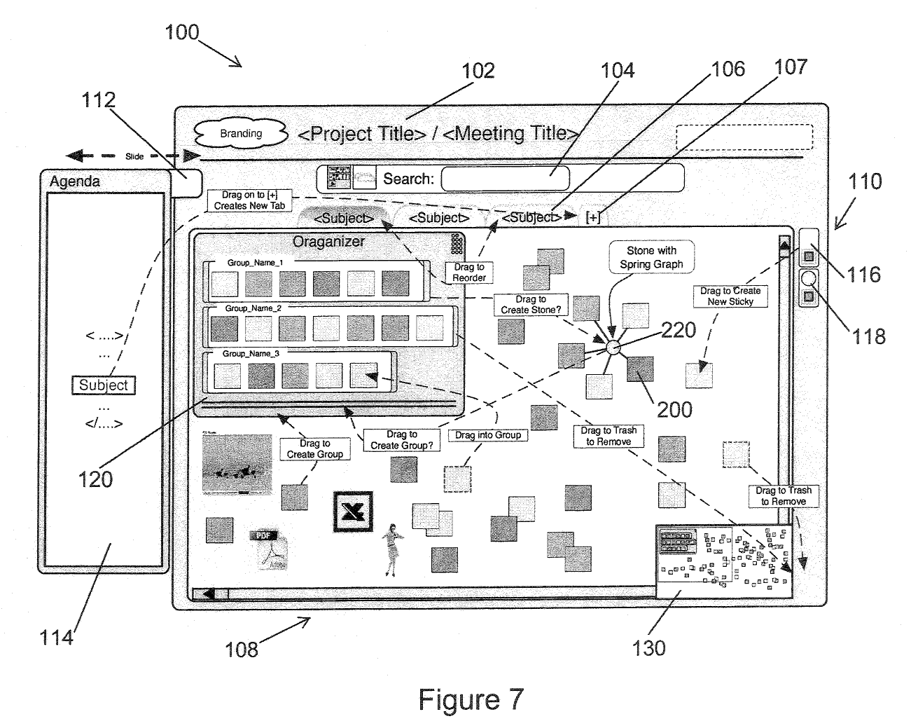

FIG. 7 illustrates an alternative embodiment of a meeting interface 100. This meeting interface 100 has a title bar 102, a tool bar 104, one or more subject tabs 106, a whiteboard space 108, an item entry selector 110, an agenda icon 112, an agenda window 114 that can be hidden and a trashcan. The title bar 102 can include appropriate branding, a project title, a meeting title and can have additional tools if room is available. The tool bar 104 can include tools to select different information views, a search tool, a refresh tool, a print/export tool and a tutorial/help tool. The different informational views can include a tabs view as shown in FIG. 7 with Subject Tabs 106 along the top of the whiteboard space 108. Alternatively, a thumbnail view can be selected in which thumbnails of the whiteboard space 108 for multiple subjects can be shown on the same screen. Other appropriate views known to those of skill in the art can also be used.

In the embodiment shown in FIG. 7, the agenda window 114 is hidden. An agenda icon 112 is displayed and when the user hovers their mouse pointer over the agenda icon 112, the agenda window 114 is shown. The agenda window 114 can include a list of subjects to be addressed at the meeting. The subjects listed in the agenda window 114 can be linked to the subject tabs 106 so the user can switch between subjects by selecting a subject from the agenda window 114. In alternative embodiments of the meeting interface, the agenda window 114 is not hidden.

The whiteboard space 108 shown in FIG. 7 includes a whiteboard area for a particular subject on which items for that subject can be placed. A user can move between subjects by selecting a different subject tab 106 at the top of the whiteboard space 108. When a different subject tab 106 is selected, the whiteboard space 108 for the selected subject is displayed covering the whiteboard space for the previously displayed subject. An add subject tab 107 can be used to add a subject to the meeting. The added subject can also be added to the agenda when the agenda window 114 is displayed. The items displayed in the whiteboard space 108 can include sticky notes, drawings, images, videos, documents in various formats (e.g., Adobe PDF, Microsoft Excel, Microsoft Word, Microsoft PowerPoint, etc.), hyperlinks, organizational tools, such as stones, and any other embedded or external content. The user can place sticky notes 200 and stones 202 on the whiteboard space 108 using the item entry selector 110 on the right side of the meeting interface 100. The item entry selector 110 can include a sticky creator 116 and a stone creator 118. The sticky creator 116 can include a sticky color selector and a new sticky icon that generates a new sticky note of the selected color. The user can enter the desired information on the newly created sticky and place the sticky on the whiteboard space 108. The stone creator 118 can include a stone color selector and a new stone icon that generates a stone of the selected color. The user can place the new stone on the whiteboard space 108 and connect sticky notes to the stone.

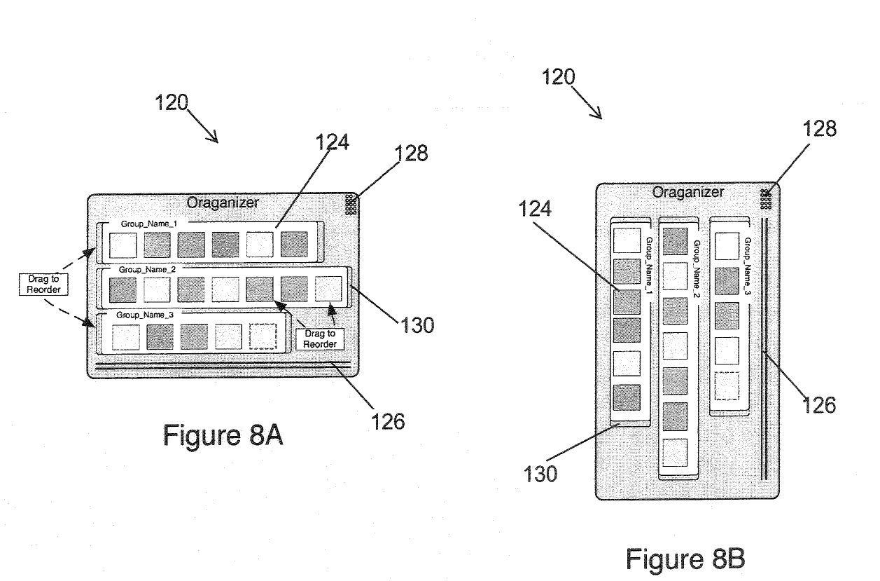

The whiteboard space 108 shown in FIG. 7 also includes an organizer window 120, also shown in FIG. 8, where related items can be grouped. The organizer window 120 includes a title, expandable group panes 124, a drop zone 126 and a gripper 128. The organizer window gripper 128 can be used to move the organizer window 120 for display in different sections of the whiteboard window 108. The organizer window 120 can be oriented horizontally (as shown in FIG. 8A) or vertically (as shown in FIG. 8B). Each group pane 124 includes a group name, a gripper 130 and scroll controls when necessary. The group pane gripper 130 can be used to drag the group pane 124 to different positions in the organizer window 120 or into the trashcan. The organizer window 120 and/or group panes 124 can be created, modified and deleted by the user.

An item can be added to a group pane 124 by dragging the item from the whiteboard space 108 into the desired position in the group pane 124. The items in a group pane 124 can be repositioned by dragging and dropping items within the group pane 124. A new group pane 124 can be created by dragging an item from the whiteboard space 108 over the drop zone 126 in the organizer window 120. When a stone 220 or anchored sticky 230 with attached items are moved into a group pane 124, then the entire assembly of items is moved together into the group pane 124.

When the necessary whiteboard space 108 exceeds the available window, the whiteboard window 108 also includes navigation bars and an optional draggable viewport 130. The viewport 130 can be a separate window. The navigation bars and viewport can be used to change the portion of the whiteboard 108 that is displayed in the whiteboard window. Items and groups can be dragged from the whiteboard space 108 and placed in the trashcan. This will remove the item from the whiteboard space 108 but will not actually delete the item from the system. Items can also be retrieved from the trashcan, and will be viewable when viewing a meeting history.

Since meeting content is “persistent”, searching for inputs from participants or other stakeholders can be easily done, even if the item has been “deleted” from a meeting/subject. All of the information contributed can be maintained to make it simple to locate information that was previously put into the system. This can be a beneficial feature for legal and tracking purposes.

The collaborative meeting space may be connected to other collaborative spaces either interactively or in a modular fashion to facilitate a more complete meeting/business process. For example, the meeting space may be connected to a collaborative presentation space for the development of business presentations or other information gathering and/or reporting processes.

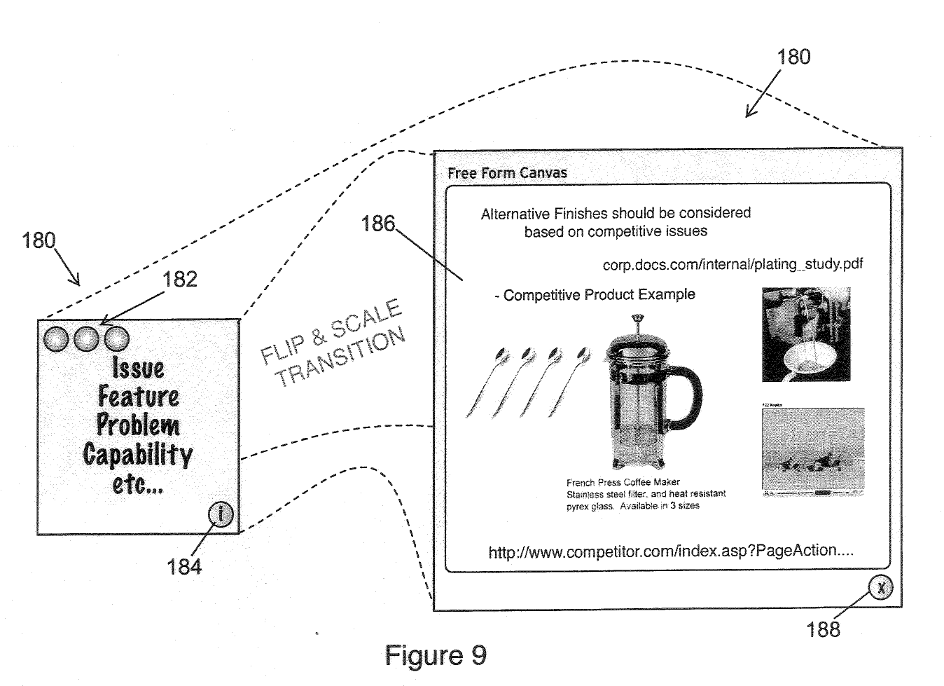

FIG. 9 illustrates an example of a note object 180, which is an item that includes several different but related attributes. The front of the note object 180 includes information describing the subject of the object 180, for example an issue, feature, problem, capability, etc. The front of the note object 180 can also include voting information 182 and an information icon 184. The information icon 184 can display additional details, references, or other information associated with the note object 180. Embodiments of a note object 180 can opened to display a canvas 186, an example of which is shown on the right side of FIG. 9. The canvas 186 can include text, images, videos, hyperlinks, documents or other information. The canvas 186 also includes a close canvas icon 188 to close the canvas 186.

Sticky notes can be considered to be “multi-sided” and may be sized as required by participants. Participants can use the front of the sticky notes for various items (e.g., drawing, writing or typing information as well as voting, and reporting) and the back side of the sticky note can also be used for the same things as the front or as a free form canvas to place or embed other content and information (e.g. hyperlinks, images, documents, drawings, text, etc.). The sticky notes can also have additional attributes, such as colors, indications of who created or owns them, their state (e.g. editable, non-editable), a security level (e.g., making them visible or invisible to a participant based on the participant's security level), and may also include the ability to be “voted” upon by participants (all voting and tallying could be done by the system). Sticky Notes can also be “extended” to add additional “sides” for specialized functionalities like time and project tracking, additional voting paradigms, or connecting to other business systems to access information which needs to be maintained and reviewed by others in the meeting in real time (e.g. remote database and/or web services, which may require information based on or to support meeting information).

A note object can be moved in the various interfaces described by putting the cursor on the note, selecting the note and moving the cursor with the selected note to the desired location. The content of a note can be revised by selecting and editing the editable portion of the note. Notes can have protections requiring certain permissions/authorizations for a participant to change the content of a note. A note can include voting information. The voting information can display both yes and no votes, or only one or the other. A note can also have additional information associated with it that is displayed only when an information icon is selected. Some notes can be reshaped, enlarged and shrunk by selecting a side or corner of the note with the cursor and moving the cursor. The size, color or other attribute of a note can change based on voting or other information. Notes can be stacked or positioned in particular locations relative to other notes or organizational tools, such as stones.

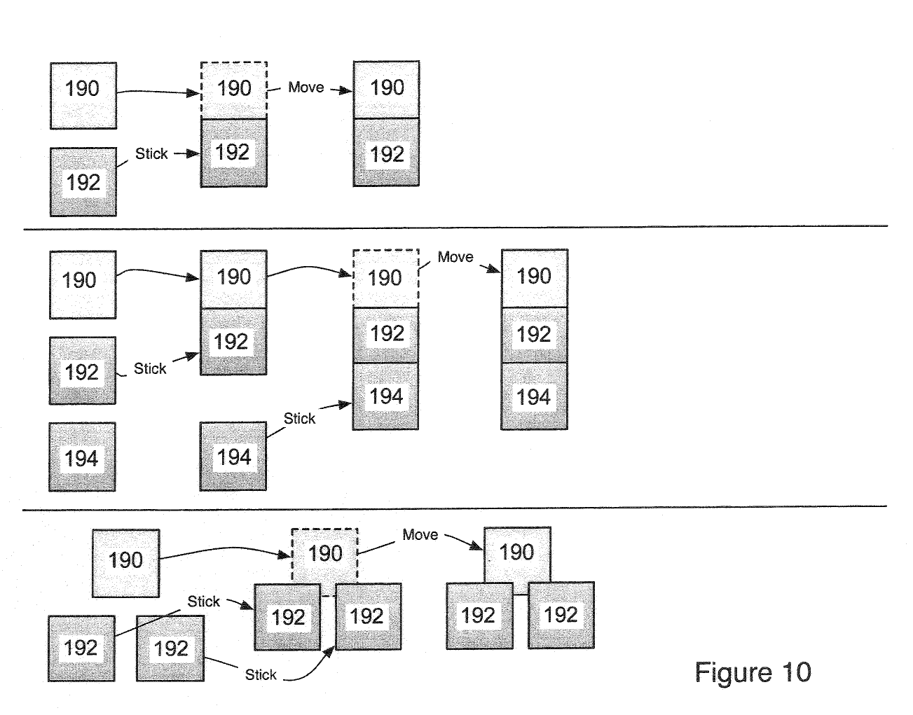

FIGS. 10 and 11 illustrate parent-child relationships between notes which can be used in embodiments of the present invention. When a note 190 is stuck at the top or bottom of another note 192 the parent-child relationship is established. The top note 190 becomes the parent and the bottom note 192 becomes the child. These notes can have an attachment area at the top and/or bottom to be used to create this parent-child relationship. When the parent note 190 is moved, the child note 192 automatically moves with the parent note 190. When the child note 192 is moved independently, the parent-child relationship is broken.

As shown in FIGS. 10 and 11, a parent note 190 can have multiple child notes 192, 194 at different levels. When a parent note 190 has a child note 192, and the child note 192 has a grandchild note 194, then (1) moving the parent note 190 automatically moves the child note 192 and grandchild note 194, (2) moving the child note 192 independent of the parent note 190 breaks the parent child relationship with note 190 but maintains the child-grandchild relationship between the notes 192 and 194 (now parent-child), and (3) moving the grandchild note 194 independent of the child note 192 maintains the parent-child relationship between the notes 190 and 192 and makes the former grandchild note 194 an independent note. When a child note has multiple parents at the same level, then different rules can be used. The child can move with the moving parent, can stay with the non-moving parent, or can be replicated so that one copy stays with the moving parent and the other copy moves with the moving parent.

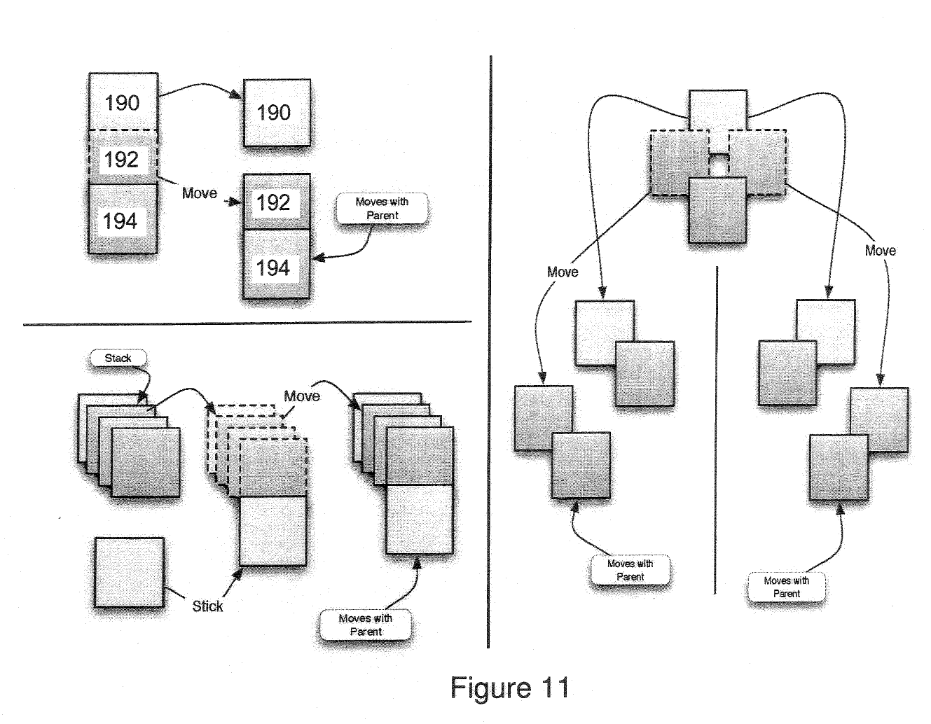

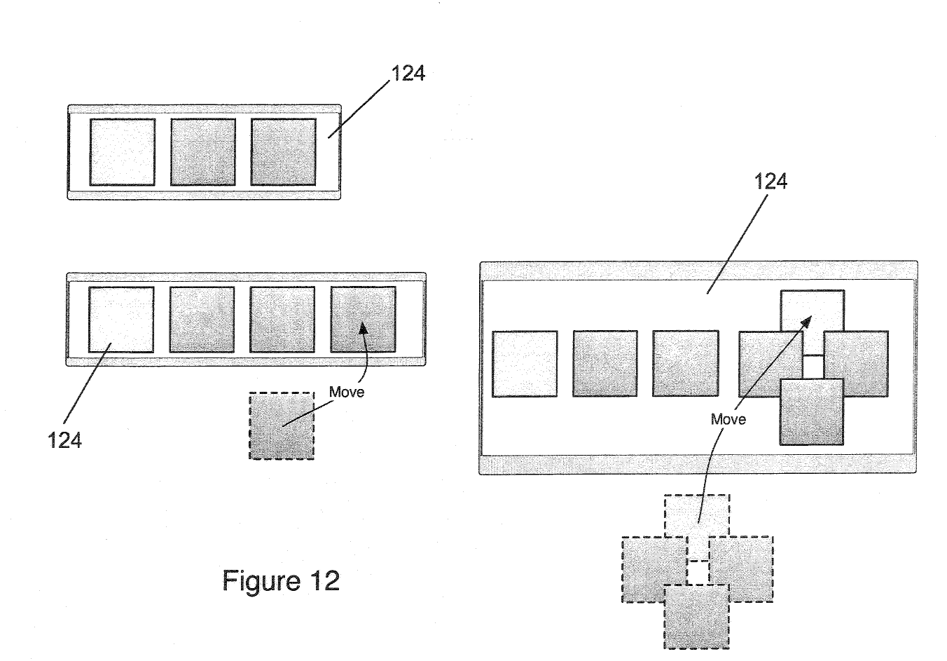

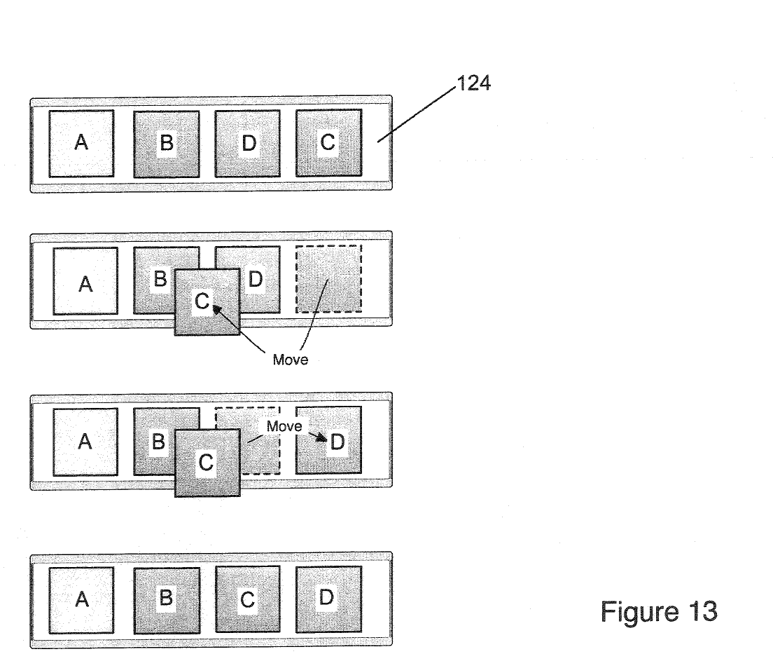

FIGS. 12-14 show various grouping behaviors for group panes 124 in the meeting interface. Items can be added to a group pane 124 by selecting an item with the cursor, dragging the item over the group pane 124, and dropping the item. The group panes 124 can be auto-sizing to expand as additional items are added to the group pane 124. The auto-sizing can be in both the horizontal and vertical directions. Items in the group pane 124 can be reordered by dragging and dropping the items in the group pane 124. The group pane 124 can also have a standard size, possibly set by the size of the organizer window 120, and when the group pane 124 exceeds that standard size it automatically acquires scroll features to allow viewing of the different items in the group pane 124. Group panes 124 can also be reordered by selecting the gripper 128 of the group pane 124 and dragging the group pane 124 to the selected position and dropping the group pane 124. All items in the group pane 124 move with the group pane 124.

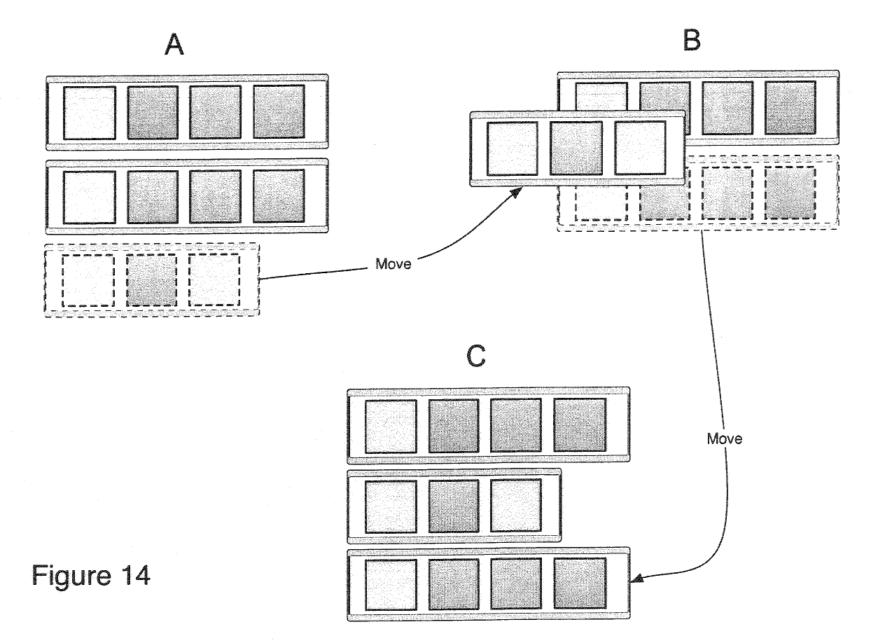

FIG. 15 illustrates the concept of a stone 220. A stone 220 can be thought of as a grouping mechanism or simply a bigger piece of paper. A stone 220 can be a unique item, an image or other item. Related items are attached to the stone 220. When the stone 220 is moved, all of the related items attached to the stone 220 move with the stone 220. A group of items attached to the stone 220 can have an organizational structure, such as a parent-child relationship, which is maintained just as it would be if those items were not attached to the stone 220.

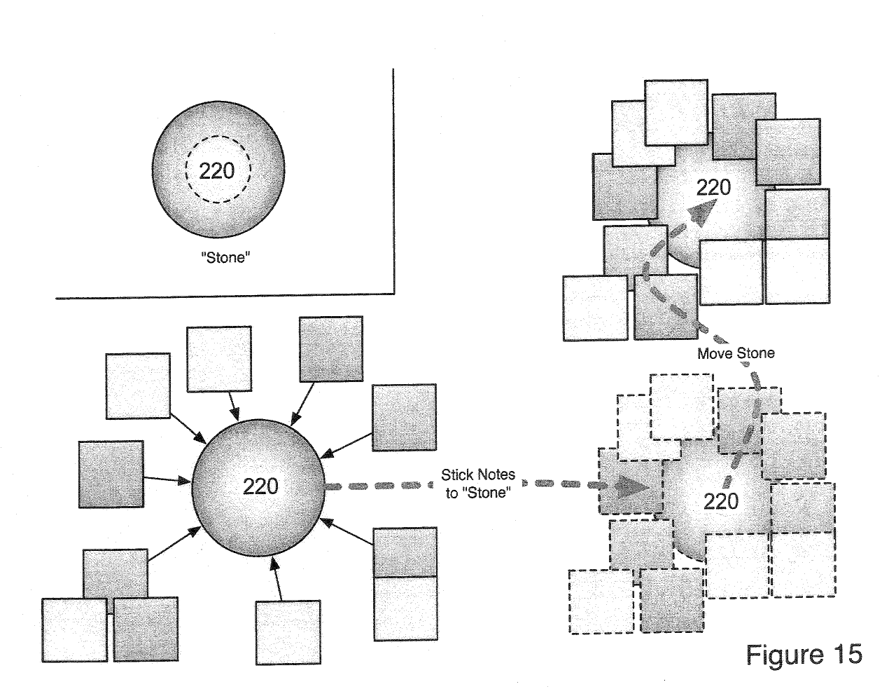

FIG. 16 illustrates the concept of an anchored note 230. Notes can have an anchor property that enables them to be used for additional organizational purposes. When the anchor property is activated, then when other notes are attached to the anchored note 230, the other notes are attached by a link. This is usually used to show ancillary items related to the anchored note 230. When the anchored note 230 is moved, all of the items attached to the anchored note 230 move with the anchored note 230. A group of items attached to the anchored note 230 can have an organizational structure, such as a parent-child relationship, which is maintained just as it would be if those items were not attached to the anchored note 230.

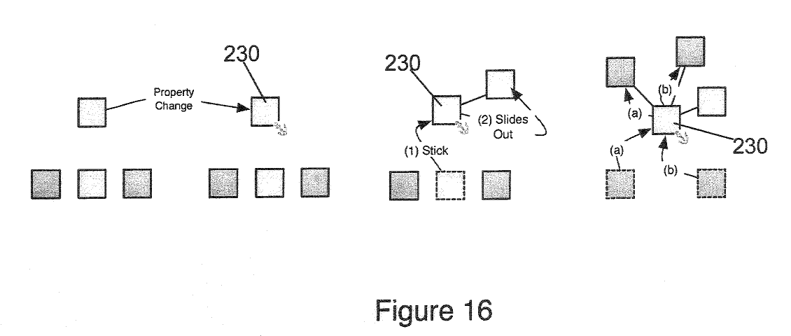

FIG. 17 illustrates equivalences between the organizing concepts of group panes 124, stones 220 and anchored notes 230. FIG. 17A shows three groups of notes, a, b and c, associated with a stone 220. FIG. 17B shows the same three groups of notes, a, b and c, associated with an anchored note 230. FIG. 17C shows the same three groups of notes, a, b and c, associated in a group pane 124. Note that the organizational structure of items attached to the stone 220 or anchored note 230 or with the group pane 124, such as a parent-child relationship, are maintained. The information associated with the anchored note 230 or stone 220 would be associated with the group as a whole in the group pane 124.

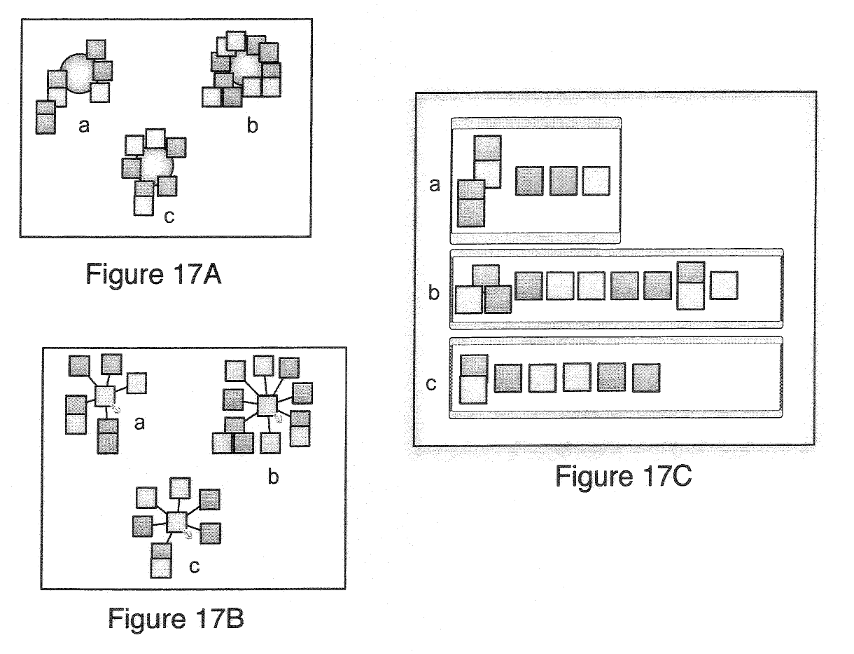

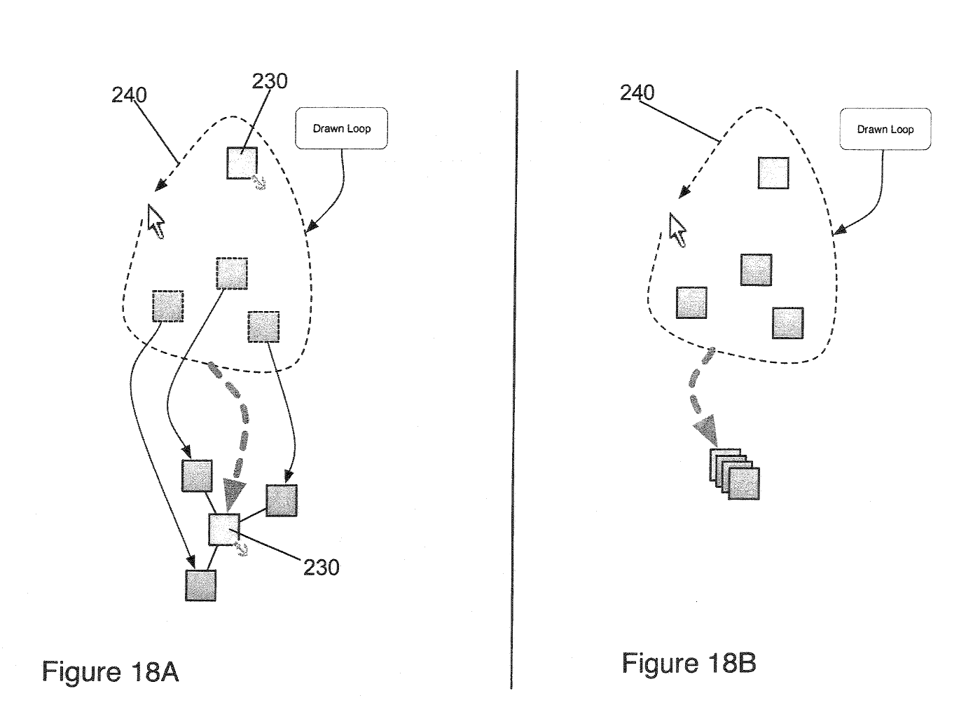

FIGS. 18A and 18B show grouping capabilities using a lasso 240 implemented in some embodiments of the system. In order to ease the organizing of notes, the cursor can be placed at a starting point and the selection button held down while the cursor is moved to surround the desired notes, then when the cursor is released the desired notes are grouped. If the lasso 240 includes an anchored note 230 or stone 220, then the other notes surrounded by the lasso 240 are attached to the anchored note 230 or stone 220. If the lasso 240 does not include an anchored note 230 or stone 220, then the notes are grouped into a stack of notes 250. Alternative selection devices known to those of skill in the art can be used, such as selecting multiple items while holding down a particular key on the keyboard.

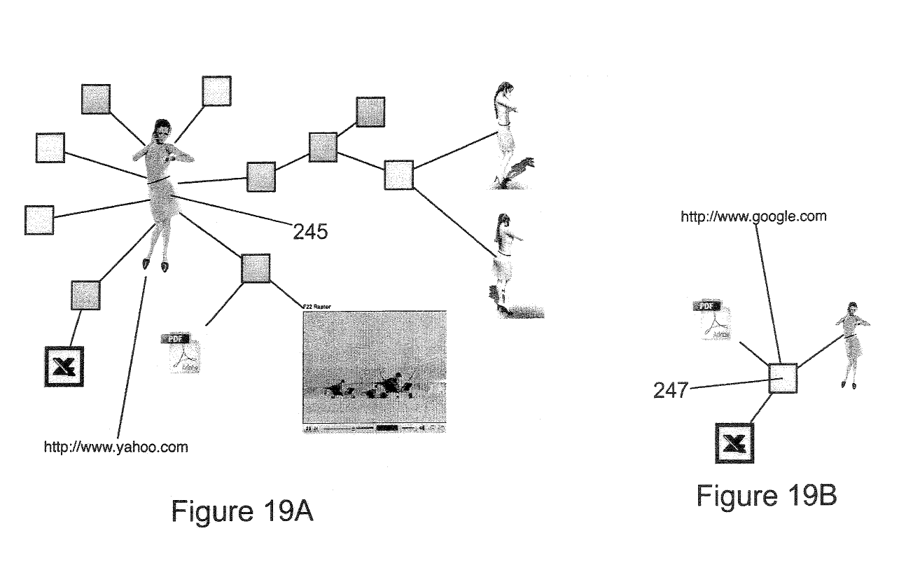

FIGS. 19A and B show other grouping and linking relationships that can be used. These grouping and linking relationships can exist between notes, and any other items, such as videos, documents, hyperlinks, etc. Any object (for example, image, sticky note, file document, external reference, hyperlink, etc.) within a meeting/subject can be used as a central idea or reference for other objects to attach to and be organized/related to. FIG. 19A shows an example of a central image 245 associated with a hyperlink and various notes, the notes being further associated with documents, other images and a video. FIG. 19B shows an example of a central note 247 associated with a hyperlink, various documents and an image.

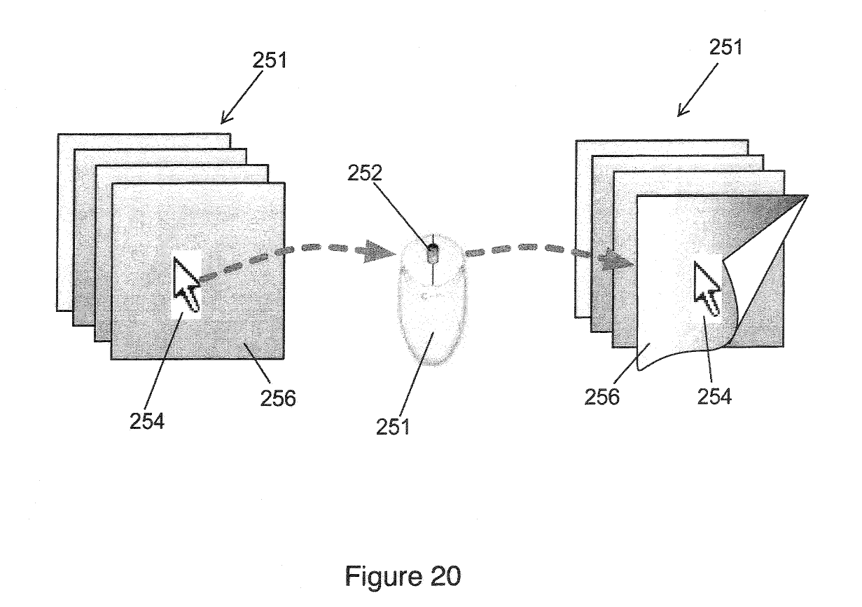

FIG. 20 shows how a mouse 251 with a cursor wheel 252 can be used to scroll through a stack of notes 258. The mouse 251 can be used to control a cursor 254. The user can position the cursor 254 on top of a top note 256 of the stack of notes 258. Then by rotating the cursor wheel 252 of the mouse 251, the top note 256 is rolled back exposing the next note of the stack of notes 258. This procedure can be repeated to view notes further down in the stack of notes 258. Alternatively, the user can position the cursor 254 to point to a lower note in the stack of notes 258 and the notes will roll back starting with the lower note in the stack of notes 258.

Exemplary embodiments of the present invention have been shown by way of example in the drawings and are herein described in detail; however the present invention is susceptible to various modifications and alternative forms. It should be understood that there is no intent to limit the system to the particular forms disclosed, but on the contrary, the intention is to address all modifications, equivalents, and alternatives falling within the spirit and scope of the system as defined herein that would occur to one skilled in the art.

We claim:

1. A system for establishing a persistent collaborative on-line meeting space for a plurality of participants, the system comprising:
an invitation module to send an invitation across a communications network to each of the plurality of participants, the plurality of participants being located at a plurality of different locations;
a logon module for establishing the identity of potential attendees and only allowing authorized participants to enter the meeting space;
a workspace module for creating a virtual workspace on a workspace computer system wherein each of the plurality of participants from the plurality of locations can create, add, organize, reorganize and delete meeting content using a participant computing device that communicates with the workspace computer system;
meeting tools to capture and organize the meeting content contributed by the plurality of participants; and
a history module for recording status, movement and modification of the meeting content and recording the activities of each of the plurality of participants during the meeting;

2. The system of claim 1, further comprising:
a permissions module for establishing a permissions level for each of the plurality of participants; wherein each of the plurality of participants from the plurality of locations can create, add, organize, reorganize and delete meeting content based on their permissions level.

3. The system of claim 1, wherein the history module includes a replay capability enabling a late participant of the plurality of participants to enter the virtual workspace after other participants have interacted in the virtual workspace, and replay the earlier activities of the other participants in the virtual workspace.

4. The system of claim 3, wherein the replay capability can be performed in accelerated or decelerated time.

5. The system of claim 1 further comprising a virtual sticky notes module, the virtual sticky notes module enabling the participants to create virtual sticky notes, and associate a desired item of meeting content with each of the virtual sticky notes.

6. The system of claim 5, wherein a security level is associated with each of the virtual sticky notes, and a classified virtual sticky note is only made visible in the virtual workspace to participants that are authorized for the security level associated with the classified virtual sticky note.

7. The system of claim 5, further comprising a voting module enabling each of the plurality of participants to vote for or against particular content in the meeting space, and
wherein one of the attributes associated with the virtual sticky notes is a vote attribute, the vote attribute tracking votes cast for or against the particular content associated with the virtual sticky note by the plurality of participants.

8. The system of claim 5, wherein the virtual sticky notes have hierarchical relationships, wherein when a child sticky note is associated with a parent sticky note a hierarchical relationship is established between the child sticky note and the parent sticky note, movement of the parent sticky note also moves the child sticky note, and movement of the child sticky note breaks the hierarchical relationship between the parent sticky note and the child sticky note.

9. The system of claim 1, wherein a plurality of meetings are available, each meeting having invited participants and a separate virtual workspace, and wherein the system further comprises:
a meeting selection module for displaying a list of available meetings and allowing a new participant of the plurality of participants to select a desired meeting from the list of available meetings, and when the desired meeting is selected, taking the new participant into the separate virtual workspace for the desired meeting.

10. The system of claim 1, wherein a plurality of meetings are available, each meeting having a separate virtual workspace, and meeting content in different meetings of the plurality of meetings can be linked, wherein changes to the linked meeting content in one meeting of the different meetings affects the linked meeting content in the other meeting of the different meeting:

11. The system of claim 1, wherein the virtual workspace is divided into an organization section and a whiteboard section, the organization section having one or more sub-panes with meeting content organized by a property determined by the participants, and the whiteboard section having additional meeting content, the meeting content being moveable by participants between the whiteboard section and the sub-panes of the organization section.

12. The system of claim 1, wherein the meeting includes an agenda listing a plurality of subjects, and the virtual workspace is separated into separate panes, each pane being associated with one of the plurality of subjects.

13. The system of claim 12, wherein the virtual workspace includes a subject tab for each of the plurality of subjects of the agenda, and the participant can view the pane associated with the desired subject by selecting the desired subject tab associated with the desired subject.

14. The system of claim 12, wherein the virtual workspace includes an agenda icon, the agenda being displayed when the participant moves a pointing device over the agenda icon and otherwise the agenda being hidden.

15. The system of claim 1, wherein the meeting tools include an organizer entity tool to create organizer entities, an organizer entity having an association property, wherein when one or more items of meeting content is associated with the organizer entity, then movement of the organizer entity also moves the one or more items of meeting content associated with the organizer entity.

16. The system of claim 15, wherein the meeting tools include a lasso tool to organize meeting content, wherein one of the plurality of participants uses the lasso tool to create a lasso surrounding a plurality of meeting content, and if the lasso does not surround an organizer entity, the lasso tool creates a stack containing each item of the plurality of meeting content surrounded by the lasso, and if the lasso surrounds an organizer entity, the lasso tool associates each item of the plurality of meeting content surrounded by the lasso with the lassoed organizer entity.

17. The system of claim 1, wherein the meeting tools include a lasso tool to organize meeting content, wherein one of the plurality of participants uses the lasso tool to create a lasso surrounding a plurality of meeting content, and the lasso tool creates a stack containing each item of the plurality of meeting content surrounded by the lasso.

18. A method for establishing a persistent collaborative on-line meeting space for a plurality of participants, the method comprising:
sending an invitation across a communications network to each of the plurality of participants, the plurality of participants being located at a plurality of different locations;
establishing the identity of potential attendees and only allowing authorized participants to enter the meeting space;
creating a virtual workspace on a workspace computer system wherein each of the plurality of participants from the plurality of locations can interact;
enabling the plurality of participants to create, add, organize, reorganize and delete meeting content using a participant computing device that communicates with the workspace computer system;
recording status, movement and modification of the meeting content and recording the activities of each of the plurality of participants during the meeting;

19. The method of claim 18, further comprising:
establishing a permissions level for each of the plurality of participants; wherein each of the plurality of participants from the plurality of locations can create, add, organize, reorganize and delete meeting content based on their permissions level.

20. The method of claim 18, further comprising:
enabling a late participant of the plurality of participants to enter the virtual workspace after other participants have interacted in the virtual workspace, and replay the earlier activities of the other participants in the virtual workspace.

21. The method of claim 18, further comprising:
enabling the participants to create a plurality of virtual sticky notes, and
enabling the participants to associate a desired item of meeting content with a desired sticky note of the plurality of virtual sticky notes.

22. The method of claim 21, further comprising:
enabling the participants to associate attributes with each of the plurality of virtual sticky notes.

23. The method of claim 22, wherein the attributes associated with the virtual sticky notes include a vote attribute, the vote attribute tracking votes cast by the plurality of participants for or against an particular item of meeting content associated with a particular virtual sticky note of the plurality of virtual sticky notes; and
enabling each of the plurality of participants to vote for or against the particular item of meeting content associated with the particular virtual sticky note.

24. The method of claim 22, wherein the attributes associated with the virtual sticky notes include a security level; and
enabling each of the plurality of participants to create classified virtual sticky notes based on a security level associated with the participant; and
only displaying the classified virtual sticky notes in the virtual workspace to participants that are authorized for the security level associated with the classified virtual sticky notes.

25. The method of claim 18, further comprising:
enabling the participants to create hierarchical relationships between desired items of the meeting content.

26. The method of claim 18, further comprising:
enabling the participants to create organizer entities, an organizer entity having an association property, wherein when one or more items of meeting content is associated with the organizer entity, then movement of the organizer entity also moves the one or more items of meeting content associated with the organizer entity.

27. The method of claim 26, further comprising:
enabling the participants to organize multiple items of meeting content by selecting a desired set of meeting content, and if one of the desired set of meeting content is an organizer entity, associating the other items of selected meeting content with the organizer entity, and if none of the desired set of meeting content is an organizer entity, stacking the desired set of meeting content to take less room in the virtual workspace.

28. A method for establishing a plurality of persistent collaborative on-line meeting spaces for a plurality of participants, the method comprising:
sending an invitation for a particular meeting of the plurality of meetings across a communications network to each of the plurality of participants, the plurality of participants being located at a plurality of different locations;
establishing the identity of potential attendees and only allowing authorized participants to enter the meeting spaces for which the potential attendee is authorized;
creating a virtual workspace on one or more workspace computer systems for each of the plurality of meetings, each of the plurality of participants for a particular meeting being enabled to interact in the virtual workspace for the particular meeting;
enabling the plurality of participants to create, add, organize, reorganize and delete meeting content using a participant computing device that communicates with the workspace computer system for the particular meeting;
recording status, movement and modification of the meeting content and recording the activities of each of the plurality of participants during the particular meeting;

29. The method of claim 28, further comprising:
displaying a list of available meetings of the plurality of meetings for which a new participant is authorized to enter;
allowing the new participant of the plurality of participants to select a desired meeting from the list of available meetings, and
when the desired meeting is selected, taking the new participant into the virtual workspace for the desired meeting.

30. The method of claim 28, further comprising:
enabling participants to link meeting content in different meetings of the plurality of meetings, wherein changes to the linked meeting content in one meeting of the different meetings affects the linked meeting content in the other meeting of the different meeting:
